(19) United States
(12) Patent Application Publication
(10) Pub. No.: US 2025/0333315 A1
(43) Pub. Date: Oct. 30, 2025

(54) NEGATIVE ACTIVE MATERIAL FOR RECHARGEABLE LITHIUM BATTERY, METHOD OF PREPARING THE SAME, AND RECHARGEABLE LITHIUM BATTERY INCLUDING THE SAME

(71) Applicant: SAMSUNG SDI CO., LTD., Yongin-si (KR)

(72) Inventors: So Jeong YU, Suwon-si (KR); Jae Hou NAH, Suwon-si (KR); Joong Ho MOON, Suwon-si (KR); Se Young OH, Suwon-si (KR); Yu Rim CHA, Suwon-si (KR); Jong Min WON, Suwon-si (KR); Hang In CHO, Suwon-si (KR)

(21) Appl. No.: 19/195,287

(22) Filed: Apr. 30, 2025

(30) Foreign Application Priority Data
Apr. 30, 2024 (KR) 10-2024-0057490

(51) Int. Cl. C01B 33/02; H01M 10/0525

(52) U.S. Cl. CPC C01B 33/02; H01M 10/0525; C01P 2002/02; C01P 2004/50; C01P 2004/84; C01P 2006/12; C01P 2006/40

(57) ABSTRACT

The present disclosure relates to a negative electrode active material for a rechargeable lithium battery, a method of preparing the same, and a rechargeable lithium battery including the same. The negative electrode active material for a rechargeable lithium battery includes a composite of silicon and amorphous carbon, and a closed pore increase rate according to Equation 1 is in a range of 20% to 100%.

$$Closed pore increase rate = ( A - B ) \times 100 \qquad Equation 1$$

in Equation 1, A denotes a sum of an increase rate of closed pores and an increase rate of open pores of the negative electrode active material according to a first measurement method, and B denotes the increase rate of open pores of the negative electrode active material according to a second measurement method.

### CROSS-REFERENCE TO RELATED APPLICATION

The present application claims priority to and the benefit of Korean Patent Application No. 10-2024-0057490, filed on Apr. 30, 2024, in the Korean Intellectual Property Office, the entire content of which is incorporated herein by reference.

### BACKGROUND

### 1. Field

The present disclosure relates to a negative active material for a rechargeable lithium battery, a method of preparing the same, and a rechargeable lithium battery including the same.

### 2. Description of the Related Art

Recently, with the rapid spread of battery-powered electronic devices, such as mobile phones, notebook computers, and electric vehicles, the demand for secondary batteries having high energy density and high capacity is rapidly increasing. Therefore, research and development have been actively conducted to improve the performance of rechargeable lithium batteries.

A rechargeable lithium battery is a battery including a positive electrode and a negative electrode, each containing an active material capable of the intercalation and deintercalation of lithium ions. The rechargeable lithium battery produces electrical energy by oxidation and reduction reactions when the lithium ions are intercalated into and deintercalated from the positive electrode and the negative electrode.

As negative electrode active materials, a crystalline carbon material such as natural graphite or artificial graphite, and/or an amorphous carbon material are mainly used. Because these carbon materials have a low capacity of about 360 mAh/g, research on silicon-based negative material active materials with a capacity four times or higher is being actively conducted.

The silicon-based negative electrode active material may have a change in volume due to expansion during charging and discharging. Therefore, it may be desirable to provide excellent lifetime and rate characteristics by reducing the change in volume of the silicon-based negative electrode active material to prevent or reduce the degradation of cycle life characteristics.

### SUMMARY

An aspect according to one or more embodiments of the present disclosure is directed toward a negative electrode active material for a rechargeable lithium battery, which provides a long lifetime and improved rate characteristics by exhibiting significantly lower volume expansion upon intercalation and deintercalation of lithium.

An aspect according to one or more embodiments of the present disclosure is directed toward a negative electrode active material for a rechargeable lithium battery, which resolves the depletion of an electrolyte caused by an increase in (e.g., the growth of) an oxide film due to volume expansion and contraction and an increase in resistance due to low conductivity if silicon is used as a negative electrode active material.

An aspect according to one or more embodiments of the present disclosure is directed toward a method of preparing the negative electrode active material for a rechargeable lithium battery.

An aspect according to one or more embodiments of the present disclosure is directed toward a rechargeable lithium battery containing the negative electrode material for a rechargeable lithium battery.

According to one or more embodiments, a negative electrode active material for a rechargeable lithium battery is provided.

The negative electrode active material for a rechargeable lithium battery includes a composite of silicon and amorphous carbon, and has a closed pore increase rate in a range of 20% to 100% according to Equation 1:

$$Closed pore increase rate = ( A - B ) \times 100 \qquad Equation 1$$

in Equation 1, A denotes a sum of an increase rate of closed pores and an increase rate of open pores of the negative electrode active material according to a first measurement method, and B denotes an increase rate of open pores of the negative electrode active material according to a second measurement method.

According to one or more embodiments, a method of preparing the negative electrode active material for a rechargeable lithium battery is provided.

The method of preparing the negative electrode active material for a rechargeable lithium battery includes: preparing a silicon particle in a first operation, and preparing a silicon-based negative electrode active material by forming an amorphous carbon coating layer on a surface of the silicon particle in a second operation, wherein, in the first operation and/or the second operation, a closed pore increase rate of the negative electrode active material according to Equation 1 is adjusted to 20% to 100%:

$$Closed pore increase rate = ( A - B ) \times 100 \qquad Equation 1$$

in Equation 1, A denotes a sum of an increase rate of closed pores and an increase rate of open pores of the negative electrode active material according to the first measurement method, and B denotes an increase rate of open pores of the negative electrode active material according to the second measurement method.

According to one or more embodiments, a rechargeable lithium battery is provided.

The rechargeable lithium battery includes a negative electrode, a positive electrode, and an electrolyte, wherein the negative electrode includes the negative electrode active material for a rechargeable lithium battery.

### BRIEF DESCRIPTION OF THE DRAWINGS

The accompanying drawings are included to provide a further understanding of the present disclosure and are incorporated in and constitute a part of this specification. The drawings illustrate embodiments of the present disclosure and, together with the description, serve to explain principles of the present disclosure.

FIG. 1 is a schematic view showing pores included in a negative electrode active material according to some embodiments.

FIGS. 2A-2C are schematic views for describing a method for measuring a closed pore increase rate according to some embodiments. FIG. 2A shows the specific surface area of an open pore, FIG. 2B shows the specific surface areas of both closed pores and open pores, and FIG. 2C shows the specific surface area of a closed pore.

FIG. 3 is a schematic illustration of a cylindrical battery according to some embodiments.

FIG. 4 is a schematic illustration of a prismatic battery according to some embodiments.

FIG. 5 is a schematic illustration of a pouch-type or kind battery according to some embodiments.

FIG. 6 is a schematic illustration of a pouch-type or kind battery according to some embodiments.

### DETAILED DESCRIPTION

Hereinafter, embodiments of the present disclosure will be described in more detail. However, the embodiments are presented as examples, and the present disclosure is not limited thereto, and the present disclosure is only defined by the scope of the appended claims and equivalents thereof.

Unless otherwise stated herein, if a part such as a layer, a membrane, an area, a plate, etc., is described as being disposed “on” another part, it includes not only a case where the part is “directly above” the other part, but also a case where there are other parts therebetween.

Unless otherwise stated herein, each element may be singular or plural. In addition, unless otherwise stated, “A or B” may refer to “including A, including B, or including A and B.”

In the present specification, “a combination thereof” may refer to a mixture, stack, composite, copolymer, alloy, blend, and/or reaction product of constituents.

Unless otherwise defined herein, a particle diameter may be an average particle diameter. In addition, the particle diameter is an average particle diameter D50, which refers to a particle diameter corresponding to a cumulative volume of 50% by volume in the particle size distribution (e.g., in a volume cumulative distribution of corresponding particles). The average particle diameter D50 may be measured by methods known to those skilled in the art, for example, measured using a particle size analyzer or measured using a transmission electron micrograph (TEM) or a scanning electron micrograph (SEM). As another method, the average particle diameter may be measured using a measurement device using dynamic light scattering, and an average particle diameter D50 value may be obtained by performing data analysis, counting the number of particles in each particle size range, and then calculating the D50 value therefrom. Alternatively, the average particle diameter may be measured using a laser diffraction method. To measure the average particle diameter by the laser diffraction method, for example, the average particle diameter D50, corresponding to 50% by volume of a particle diameter distribution, may be calculated by dispersing particles to be measured in a dispersion medium, then introducing the dispersion medium into a commercially available laser diffraction particle diameter measuring device (e.g., Microtrac's MT 3000), and radiating ultrasonic waves of about 28 kHz at an output power of 60 W, followed by calculating the average particle size (D50) corresponding to 50% by volume (vol %) in the cumulative volume distribution of the particles.

### Negative Electrode Active Material

The negative electrode active material for a rechargeable lithium battery according to one or more embodiments may include a composite of silicon and amorphous carbon. This material may exhibit significantly lower volume expansion and contraction upon intercalation and deintercalation of lithium, and provide a longer lifetime and improved rate characteristics. The negative electrode active material for a rechargeable lithium battery according to one or more embodiments can provide a long lifetime and improved rate characteristics by resolving the depletion of an electrolyte caused by an increase in (e.g., growth of) an oxide film due to volume expansion and contraction and an increase in resistance due to low conductivity when silicon is used as the negative electrode active material.

The negative electrode active material has a closed pore increase rate in a range of (e.g., ranging from) 20% to 100%, which will be described below.

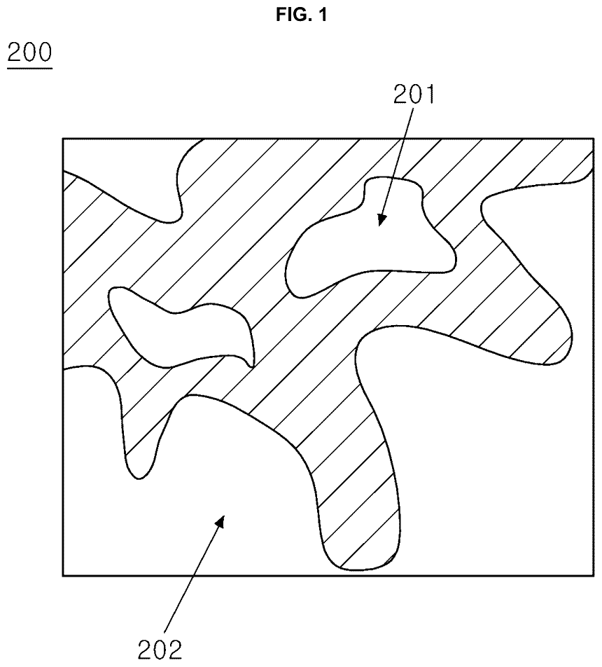

First, pores included in the negative electrode active material will be described with reference to FIG. 1. FIG. 1 is a schematic view showing pores included in a negative electrode active material.

Referring to FIG. 1, a negative electrode active material 200 includes pores 201 and 202. The pores 201 and 202 include, for example, a closed pore 201 and an open pore 202. The closed pore 201 may be a pore in a shape in which the pore is not connected to the outside and is completely closed to the outside. The open pore 202 may be a pore in a shape in which at least a portion of the pore is connected to the outside. Here, “outside” may include one or more of silicon or a modified form thereof included in the negative electrode active material and/or amorphous carbon or a modified form thereof included in the negative electrode active material.

Pores including the closed pore and the open pore are formed at any location in the negative electrode active material, and there is no limitation on locations where the pores are formed in the negative electrode active material.

According to one or more embodiments, the negative electrode active material may be in the form of a silicon particle and amorphous carbon with which a surface of the silicon particle is coated.

For example, the negative electrode active material may include a secondary particle (core) in which silicon primary particles are assembled (e.g., agglomerated) and an amorphous carbon coating layer (shell) located on a surface of the secondary particle. The amorphous carbon may also be located between the silicon primary particles so that the silicon primary particles may be coated with the amorphous carbon. The secondary particle may be dispersed in an amorphous carbon matrix. In this case, the pores including the closed pore and the open pore may be dispersed in one or more of the core, the shell, and/or an interface between the core and the shell.

The amorphous carbon may be soft carbon, hard carbon, pitch, pitch carbide, calcined coke, or a combination thereof.

According to one or more embodiments, the amorphous carbon coating layer may include a carbide of a mixture of two or more types or kinds of amorphous carbon with different softening points or a mixture of two or more types or kinds of amorphous carbon with different softening points.

According to one or more embodiments, the mixture of the amorphous carbon may be a mixture of a first amorphous carbon and a second amorphous carbon with different softening points.

For convenience, the softening point of the first amorphous carbon is defined as being lower than the softening point of the second amorphous carbon.

According to one or more embodiments, the softening point of the first amorphous carbon may be 100° C. or higher and 250° C. or lower, for example, 100° C. or higher and 200° C. or lower, or 100° C. or higher and 150° C. or lower.

According to one or more embodiments, the softening point of the second amorphous carbon may be higher than 250° C. and 500° C. or lower, for example, higher than 250° C. and 400° C. or lower, or higher than 250° C. and 300° C. or lower.

A weight ratio of the first amorphous carbon and the second amorphous carbon may be (e.g., range from) 40:60 to 90:10, for example, 50:50 to 90:10, or 60:40 to 90:10 among 100 parts by weight of a mixture of the first amorphous carbon and the second amorphous carbon.

According to one or more embodiments, the core may include closed pores and open pores.

According to one or more embodiments, the content of silicon may be (e.g., range from) 50 wt % to 95 wt % among a total of 100 wt % of the negative electrode active material. In addition, the content of the amorphous carbon may be (e.g., range from) 5 wt % to 50 wt % among a total of 100 wt % of the negative electrode active material. If the content of silicon and the content of amorphous carbon are within the above ranges, the negative electrode active material may exhibit appropriate electrical conductivity, thereby exhibiting excellent charge/discharge efficiency.

According to another embodiment, the negative electrode active material may further include crystalline carbon. For example, the negative electrode active material may include a core containing crystalline carbon and a silicon particle and an amorphous carbon coating layer (shell) located on a surface of the core. In this case, the pores including the closed pores and the open pores may be dispersed in one or more of the core, the shell, and/or an interface between the core and the shell.

The crystalline carbon may include one or more of artificial graphite and natural graphite.

The negative electrode active material has a closed pore increase rate in a range of (e.g., ranging from) 20% to 100% according to Equation 1 below:

$$Closed pore increase rate = ( A - B ) \times 100 \qquad Equation 1$$

in Equation 1, A denotes increase rates of closed pores and open pores of the negative electrode active material according to a first measurement method, and B denotes an increase rate of open pores of the negative electrode active material according to a second measurement method. That is, in Equation 1, A represents the total increase rates of both closed pores and open pores, and B represents only the increase rate of open pores.

The closed pore has a shape that is not connected to the outside and has a closed form. Therefore, the closed pore can mitigate the volume expansion and contraction of silicon by further providing a buffer function capable of absorbing the volume expansion and contraction of silicon if the volume of silicon changes during intercalation and deintercalation of lithium ions. The closed pore may provide a relatively larger buffer function compared to the open pore. However, if too many closed pores are formed in the negative electrode active material, the negative electrode active material may not be suitable to serve as a negative electrode active material. The closed pore increase rate according to Equation 1 was set to increase the buffer function against the volume expansion and contraction of silicon of the negative electrode active material due to the closed pores and provide the intercalation and deintercalation function of lithium as the negative electrode active material.

If the closed pore increase rate is 20% or more, the volume expansion of silicon may be sufficiently absorbed during intercalation and deintercalation of lithium, thereby reducing cracking and crumbling during repeated charging and discharging, and thus it is possible to provide a long lifetime and improved rate characteristics for the negative electrode active material and the rechargeable lithium battery including the same.

If the closed pore increase rate is 100% or less, it is possible to minimize or reduce difficulties in electrode plate processability such as twisting characteristics due to an excessive increase in closed pores and obtain high energy density.

For example, the closed pore increase rate may be (e.g., range from) 30% to 50%.

Currently, there is no known method of measuring the degree of formation of the closed pores included in the negative electrode active material. Typically, a Brunauer-Emmett-Teller (BET) analysis method is used as a method of measuring the pores of the negative electrode active material. However, the BET analysis method, which is a method of adsorbing gas into pores and quantifying the adsorbed gas, is limited to measuring only open pores, and may have a limitation in measuring closed pores. This may be sufficiently shown by the shape of the closed pore in FIG. 1.

The closed pore and the open pore each have a surface area as shown in FIG. 1. The closed pores and the open pores may be generated, destroyed, or changed in a process of preparing the negative electrode active material. Therefore, the surface areas of the closed pores and the open pores at one point in the process of forming the negative electrode active material may differ from those of the closed pores and the open pores of the (e.g., finally formed) negative electrode active material. Therefore, the closed pore and the open pore may each cause a change in surface area.

In the present disclosure, for the negative electrode active material, the closed pore increase rate of Equation 1 was calculated through the increase rates of the closed pores and the open pores at one point in the process of forming the negative electrode active material.

In the present disclosure, “specific surface area” is used to obtain the closed pore increase rate. The specific surface area may be a surface area per unit mass of the negative electrode active material. In addition, the specific surface area may be a surface area per unit mass of an intermediate, for example, a silicon primary particle or a secondary particle in which silicon primary particles are assembled (e.g., agglomerated) in the process of preparing the negative electrode active material. The unit of the specific surface area is m²/g.

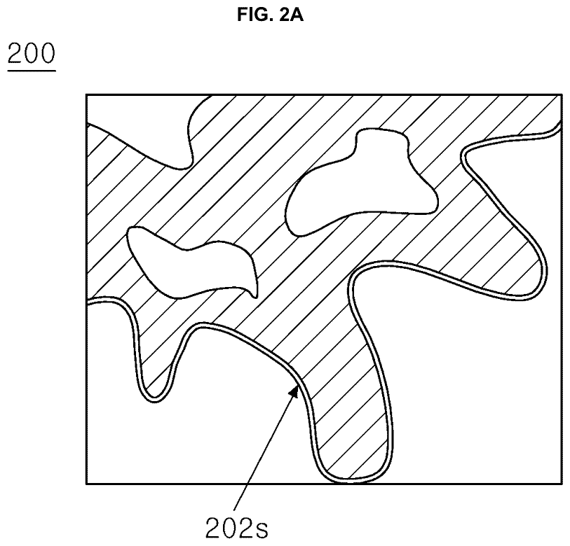

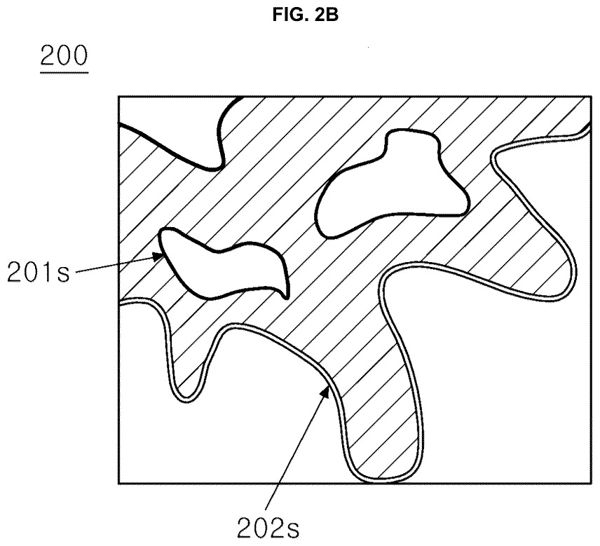

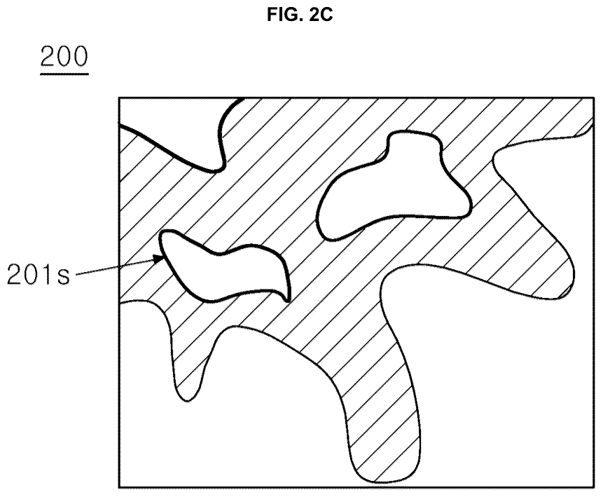

The closed pore increase rate of Equation 1 was derived by a method of measuring the increase rate of the closed pores through a difference between the increase rates of the closed pores and the open pores by the specific surface area and the increase rate of the open pores by the specific surface area. In this regard, the specific surface area of the open pore, the specific surface areas of the pores including the open pore and the closed pore, and the specific surface area of the closed pore will be described with reference to FIG. 2.

FIGS. 2A to 2C are each a schematic view for describing a method of measuring a closed pore increase rate according to one or more embodiments.

FIG. 2A shows the specific surface area of an open pore. FIG. 2B shows the specific surface areas of both closed pores and open pores. FIG. 2C shows the specific surface area of a closed pore.

The negative electrode active material 200 includes the closed pores 201 and the open pores 202. The closed pore 201 includes a specific surface area 201s of the closed pore. The open pore 202 includes a specific surface area 202s of the open pore. The specific surface areas of pores including at least one of the closed pore 201 and the open pore 202 may be measured through a first measurement method.

The first measurement method may include, for example, small-angle X-ray scattering (SAXS).

According to one or more embodiments, SAXS measurements may be performed on powders of the negative electrode active material.

The negative electrode active material 200 includes the open pores 202. The open pore 202 includes the specific surface area 202s of the open pore. The specific surface area 202s of the open pore is measured through a second measurement method. The second measurement method may include, for example, a BET analysis method, a mercury porosity analysis method, etc. In some embodiments, the second measurement method may be a BET analysis method.

According to one or more embodiments, BET measurements may be performed on powders of the negative electrode active material.

FIG. 2C shows the specific surface area of a closed pore. A measurement method of directly measuring only the specific surface area of the closed pore has not yet been found. Therefore, the method of measuring the closed pore increase rate of Equation 1 according to one or more embodiments, may be calculated through a change in the closed pore 201 through the specific surface areas of the closed pore 201 and the open pore 202 and the specific surface area of the open pore 202.

According to one or more embodiments, A (closed pore and open pore increase rates) in Equation 1 may be calculated according to Equation 2 below:

$$A = \frac{EA - PA}{PA} \qquad Equation 2$$

in Equation 2, PA denotes a specific surface area according to the first measurement method before the open pore and the closed pore of the negative electrode active material are formed, and EA denotes a specific surface area according to the first measurement method after the open pore and the closed pore of the negative electrode active material are formed.

Equation 2 includes both an increase rate due to open pores and an increase rate due to closed pores. That is, in Equation 2, EA represents the total increase rate of both open pores and closed pores.

According to one or more embodiments, the first measurement method used for Equation 2 may include SAXS.

According to one or more embodiments, PA may be measured at any stage before the open pore and the closed pore are formed in the negative electrode active material.

According to one or more embodiments, PA may be measured before an amorphous carbon coating layer is formed in the method of preparing the negative electrode active material, which will be described below.

For example, PA may be measured for silicon particles. For example, PA may be measured for a secondary particle in which silicon primary particles are assembled (e.g., agglomerated). For example, PA may be measured for silicon primary particles. In some embodiments, PA may be measured for the secondary particle in which the silicon primary particles are assembled.

According to one or more embodiments, EA may be measured for the negative electrode active material. That is, EA may be measured for the finally formed negative electrode active material.

According to one or more embodiments, B (open pore increase rate) in Equation 1 may be calculated according to Equation 3 below:

$$B = \frac{EB - PB}{PB} \qquad Equation 3$$

in Equation 3, PB denotes a specific surface area according to the second measurement method before the open pore and the closed pore of the negative electrode active material are formed, and EB denotes a specific surface area according to the second measurement method after the open pore and the closed pore of the negative electrode active material are formed.

Equation 3 includes only the increase rate due to open pores.

According to one or more embodiments, the second measurement method in Equation 3 may include a BET method.

According to one or more embodiments, PB may be measured at any stage before the open pore and the closed pore are formed in the negative electrode active material.

According to one or more embodiments, PB may be measured before an amorphous carbon coating layer is formed in the method of preparing the negative electrode active material, which will be described below.

For example, PB may be measured for silicon particles. For example, PB may be measured for a secondary particle in which silicon primary particles are assembled. For example, PB may be measured for silicon primary particles. In some embodiments, PB may be measured for the secondary particle in which the silicon primary particles are assembled.

According to one or more embodiments, EB may be measured for the negative electrode active material. That is, EB may be measured for the finally formed negative electrode active material.

According to one or more embodiments, a closed pore increase rate in a range of (e.g., ranging from) 20% to 100% according to Equation 1 may be achieved in any operation of the method of preparing the negative electrode active material. Hereinafter, the method of preparing the negative electrode active material will be described.

### Method of Preparing Negative Electrode Active Material

The method of preparing the negative electrode active material includes a first operation of providing a silicon particle, and a second operation of preparing a negative electrode active material by forming an amorphous carbon coating layer on a surface of the silicon particle, wherein, in one or both of the first operation and the second operation, a closed pore increase rate of the negative electrode active material according to Equation 1 below is adjusted to 20% to 100%:

$$Closed pore increase rate = ( A - B ) \times 100 \qquad Equation 1$$

in Equation 1, A denotes increase rates of closed pores and open pores of the negative electrode active material according to a first measurement method, and B denotes an increase rate of open pores of the negative electrode active material according to a second measurement method.

Because the closed pore increase rate of Equation 1 has been described above, detailed description thereof is not repeated. Therefore, hereinafter, the first operation, the second operation, and the adjusting of the closed pore increase rate of Equation 1 to a range of 20% to 100% will be described.

### First Operation

The first operation is an operation of providing silicon particles.

According to one or more embodiments, the silicon particle may include a secondary particle in which the silicon primary particles are assembled (e.g., agglomerated). The secondary particle is in the form in which two or more silicon primary particles are agglomerated. The secondary particle may be prepared by a suitable methods known to those skilled in the art.

According to one or more embodiments, the silicon particle may be non-porous or porous.

According to one implementation, the silicon particle may include a thermally decomposable material. The thermally decomposable material may promote the formation of pores in the negative electrode active material by being thermally decomposed in a heat treatment operation to be described below.

According to one or more embodiments, the thermally decomposable material may be a material that is thermally decomposed by at least 50 wt %, for example, at least 70 wt %, at least 90 wt %, or 100 wt % in the heat treatment operation. For example, the thermally decomposable material may include a polystyrene-based or polymethyl methacrylate-based resin or copolymer.

The thermally decomposable material may be contained in an amount of (e.g., ranging from) 0.1 to 3 wt %, for example, from 0.5 to 2 wt % of the silicon particle. If the thermally decomposable material is included within the above ranges, a closed pore increase rate in a range of (e.g., ranging from) 20% to 100% according to Equation 1 can be achieved (e.g., easily achieved).

### Second Operation

The second operation is an operation of preparing a negative electrode active material by forming an amorphous carbon coating layer on the surface of the silicon particle.

According to one or more embodiments, the amorphous carbon coating layer may be manufactured by mixing the silicon particles and the amorphous carbon and thermally treating the mixture. According to one or more embodiments, the amorphous coating layer may contain a carbide of the amorphous carbon.

According to one or more embodiments, the mixing of the silicon particles and the amorphous carbon may be performed by one or more of dry mixing and wet mixing. The dry mixing may include physically mixing the silicon particles and the amorphous carbon without a solvent. The wet mixing may include mixing a solution in which the amorphous carbon is dissolved and the silicon particles.

A mixing ratio of the silicon particles and the amorphous carbon may be a weight ratio of 95:5 to 50:50, and according to one or more embodiments, may be a weight ratio of 90:10 to 60:40 based on a total of 100 parts by weight of the silicon particles and amorphous carbon. If the mixing ratio of the silicon particles and the amorphous carbon is within the above ranges, better or superior electrical conductivity may be obtained and the shape of the composite may be maintained better. In addition, if the mixing ratio is within the above ranges, a negative electrode active material that satisfies the closed pore increase rate may be easily prepared.

The amorphous carbon may be soft carbon, hard carbon, pitch, pitch carbide, calcined coke, or a combination thereof.

According to one or more embodiments, the softening point of the amorphous carbon may be (e.g., range from) 100° C. to 500° C., for example, 100° C. to 300° C. The “softening point” may be determined by suitable methods known to those skilled in the art.

The heat treatment may be performed on the mixture at a heat treatment temperature in a range of (e.g., ranging from) 700° C. to 1000° C. The heat treatment may be performed under an inert gas such as a nitrogen or argon atmosphere. The heat treatment may be performed for 1 to 5 hours.

According to one or more embodiments, the heat treatment may be performed after raising the temperature from a heat treatment start temperature to the heat treatment temperature.

For example, the heat treatment start temperature may be room temperature, for example, a temperature in a range of (e.g., ranging from) 10° C. to 40° C. or from 20° C. to 30° C.

A temperature increase rate when raising the temperature may be 2° C./min to 20° C./min, for example, 5° C./min to 20° C./min, 5° C./min to 15° C./min, 5° C./min to 10° C./min, or 10° C./min.

If the heat treatment is performed under the above conditions, the negative electrode active material may be suitably or easily prepared.

### Adjustment of Closed Pore Increase Rate of Equation 1

A closed pore increase rate in a range of (e.g., ranging from) 20% to 100% according to Equation 1 may be achieved by adjusting the temperature increase rate during the heat treatment, adjusting the softening point of the amorphous carbon, and/or using the thermally decomposable material in the operation of preparing the silicon particle.

(1) According to one or more embodiments, a closed pore increase rate in a range of (e.g., ranging from) 20% to 100% according to Equation 1 may be achieved by adjusting the temperature increase rate during the heat treatment. To this end, the temperature increase rate may be 5° C./min to 20° C./min or 5° C./min to 15° C./min. Within the above ranges, a negative electrode active material having the above closed pore increase rate according to Equation 1 may be prepared.

In this case, the heat treatment start temperature may be a temperature in a range of (e.g., ranging from) 10° C. to 40° C. or from 20° C. to 30° C. The heat treatment temperature may be a temperature in a range of (e.g., ranging from) 700° C. to 1000° C., for example, from 800° C. to 1000° C. or from 900° C. to 1000° C. The heat treatment may be performed for 1 hour to 5 hours, for example, 1 hour to 4 hours, 1 hour to 3 hours, or 2 hours.

(1) According to one or more embodiments, two or more types or kinds of amorphous carbon with different softening points may be used to achieve a closed pore increase rate in a range of (e.g., ranging from) 20% to 100% according to Equation 1. In some embodiments, two types or kinds of amorphous carbon with different softening points may be used. In some embodiments, the amorphous carbon may be pitch.

According to one or more embodiments, the amorphous carbon may be a mixture of a first amorphous carbon and a second amorphous carbon with different softening points.

For convenience, the softening point of the first amorphous carbon is defined as being lower than the softening point of the second amorphous carbon.

According to one or more embodiments, the softening point of the first amorphous carbon may be 100° C. or higher and 250° C. or lower, for example, 100° C. or higher and 200° C. or lower or 100° C. or higher and 150° C. or lower.

According to one or more embodiments, the softening point of the second amorphous carbon may be higher than 250° C. and 500° C. or lower, for example, higher than 250° C. and 400° C. or lower or higher than 250° C. and 300° C. or lower.

If applying a mixture of the first amorphous carbon and the second amorphous carbon having the above softening points, a negative electrode active material that satisfies a closed pore increase rate in a range of (e.g., ranging from) 20% to 100% according to Equation 1 may be prepared.

The first amorphous carbon and the second amorphous carbon may be mixed in an appropriate ratio.

According to one or more embodiments, a weight ratio of the first amorphous carbon and the second amorphous carbon may be (e.g., range from) 40:60 to 90:10, for example, 50:50 to 90:10, or 60:40 to 90:10 among 100 parts by weight of the mixture of the first amorphous carbon and the second amorphous carbon. Within the above ranges, a negative electrode active material that satisfies a closed pore increase rate in a range of (e.g., ranging from) 20% to 100% according to Equation 1 may be prepared.

The first amorphous carbon and the second amorphous carbon may be used concurrently (or simultaneously) or sequentially in the heat treatment operation.

(3) According to one or more embodiments, a closed pore increase rate in a range of (e.g., ranging from) 20% to 100% according to Equation may be achieved by using the thermally decomposable material in the operation of preparing the silicon particle.

The silicon particle may include the thermally decomposable material. The thermally decomposable material may promote the formation of pores in the negative electrode active material by being thermally decomposed in a heat treatment operation to be described below.

According to one or more embodiments, the thermally decomposable material may be a material that is thermally decomposed by at least 50 wt %, for example, at least 70%, at least 90 wt %, or 100% in the heat treatment operation. For example, the thermally decomposable material may include a polystyrene-based or polymethyl methacrylate-based resin or copolymer.

The thermally decomposable material may be contained in an amount in a range of (e.g., ranging from) 0.1 to 3 wt %, for example, 0.5 to 2 wt % based on 100 wt % of the silicon particle. Within these ranges, a closed pore increase rate in a range of (e.g., ranging from) 20% to 100% according to Equation 1 can be obtained (e.g., easily reached).

A closed pore increase rate in a range of (e.g., ranging from) 20% to 100% according to Equation 1 can be achieved by (1), (2), or (3) alone or a combination of two or more of (1), (2), and (3).

### Rechargeable Lithium Battery

According to one or more embodiments, the rechargeable lithium battery includes a negative electrode including the negative electrode active material, a positive electrode; and an electrolyte.

### Positive Electrode

A positive electrode for a rechargeable lithium battery may include a current collector and a positive electrode active material layer on the current collector. The positive electrode active material layer may include a positive electrode active material and may further include a binder and/or a conductive material.

In some embodiments, the positive electrode may further include an additive that can serve as a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal selected from cobalt, manganese, nickel, and combinations thereof may be used.

The composite oxide may be a lithium transition metal composite oxide. Examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O₂₋ₐDₐ (0.90≤a≤1.8, 0≤b≤0.5, 0≤c≤0.5, and 0<a<2); LiₐNi_{1-b-c}Mn_{b}X_{c}O₂₋ₐDₐ (0.90≤a≤1.8, 0≤b≤0.5, 0≤c≤0.5, and 0<a<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂GbO₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L¹ is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of all metals excluding lithium in the lithium transition metal composite oxide. The high-nickel-based positive electrode active material may be capable of realizing high capacity and can be applied to a high-capacity, high-density rechargeable lithium battery.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles (e.g., well) to each other and also to attach the positive electrode active material (e.g., well) to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and/or the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector, but the present disclosure is not limited thereto.

### Negative Electrode

The negative electrode for a rechargeable lithium battery may include a current collector and a negative electrode active material layer on the current collector.

The negative electrode active material layer includes the negative electrode active material. The negative electrode active material layer may further include other negative electrode active material.

The negative electrode active material layer may further include a binder and/or a conductive material (e.g., an electrically conductive material).

For convenience, the negative active material according to embodiments of the present disclosure is referred to as a first negative active material, and the other different negative electrode active materials are referred to as a second negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The second negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped (irregularly shaped), sheet-shaped, flake-shaped, sphere-shaped, or fiber-shaped, natural graphite or artificial graphite. The amorphous carbon may be a soft carbon, a hard carbon, a mesophase pitch carbonization product, calcined coke, and/or the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x≤2), a Si-Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnOx (0<x≤2, e.g., SnO₂), a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

The binder may serve to attach the negative electrode active material particles (e.g., well) to each other and also to attach the negative electrode active material (e.g., well) to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

If an aqueous binder is used as the negative electrode binder, a cellulose-based compound capable of imparting (e.g., adjusting) viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous (e.g., being formed in the shape of fibers). For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

The rechargeable lithium battery may further include an electrolyte solution.

### Electrolyte Solution

The electrolyte solution for a rechargeable lithium battery may include a non-aqueous organic solvent and a lithium salt.

The non-aqueous organic solvent may serve as a medium for transmitting ions taking part in the electrochemical reaction of a battery.

The non-aqueous organic solvent may be a carbonate-based, ester-based, ether-based, ketone-based, or alcohol-based solvent, an aprotic solvent, or a combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In addition, the ketone-based solvent may include cyclohexanone, and/or the like. The alcohol-based solvent may include ethanol, isopropyl alcohol, and/or the like and the aprotic solvent may include nitriles such as R—CN (wherein R is a C2 to C20 linear, branched, or cyclic hydrocarbon group, a double bond, an aromatic ring, or an ether bond, and/or the like; amides such as dimethylformamide; dioxolanes such as 1,3-dioxolane, 1,4-dioxolane, and/or the like; sulfolanes, and/or the like.

The non-aqueous organic solvents may be used alone or in combination of two or more.

In addition, if using a carbonate-based solvent, a mixture of a cyclic carbonate and a chain carbonate may be used, and the cyclic carbonate and the chain carbonate may be mixed in a volume ratio of about 1:1 to about 1:9.

The lithium salt dissolved in the organic solvent supplies lithium ions in a battery, enables a basic operation of a rechargeable lithium battery, and improves transportation of the lithium ions between positive and negative electrodes. Examples of the lithium salt include at least one selected from LiPF₆, LiBF₄, LiSbF₆, LiAsF₆, LiClO₄, LiAlO₂, LiAlCl₄, LiPO₂F₂, LiCl, Lil, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (wherein x and y are integers of 1 to 20), lithium trifluoromethane sulfonate, lithium tetrafluoroethanesulfonate, lithium difluorobis(oxalato)phosphate (LiDFOB), and lithium bis(oxalato) borate (LiBOB).

Depending on the type or kind of the rechargeable lithium battery, a separator may be present between the positive electrode and the negative electrode. The separator may include polyethylene, polypropylene, polyvinylidene fluoride, a multilayer film of two or more layers thereof, or a mixed multilayer film such as a polyethylene/polypropylene two-layer separator, polyethylene/polypropylene/polyethylene three-layer separator, polypropylene/polyethylene/polypropylene three-layer separator, and/or the like.

The separator may include a porous substrate and a coating layer including an organic material, an inorganic material, or a combination thereof on one or both surfaces of the porous substrate.

The porous substrate may be a polymer film formed of any one selected polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but the present disclosure is not limited thereto.

The organic material and the inorganic material may be mixed in one coating layer, or a coating layer including an organic material and a coating layer including an inorganic material may be stacked.

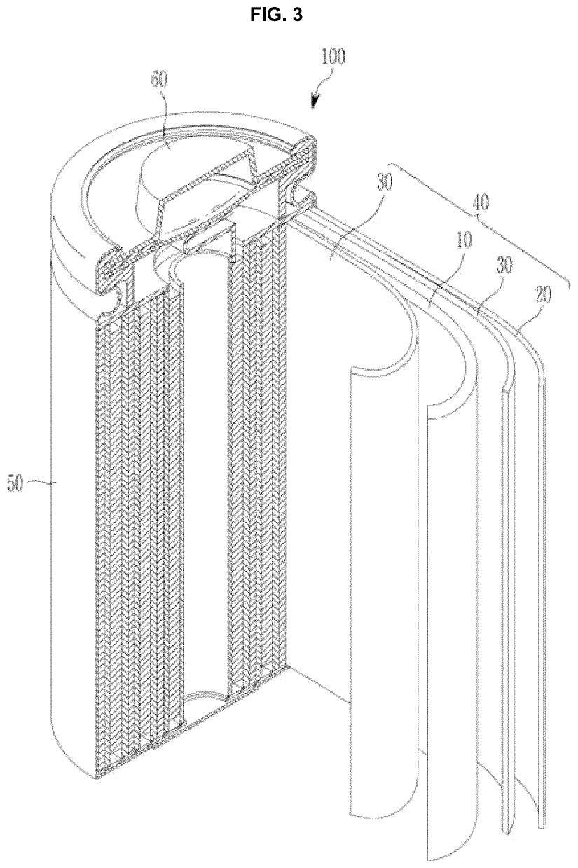

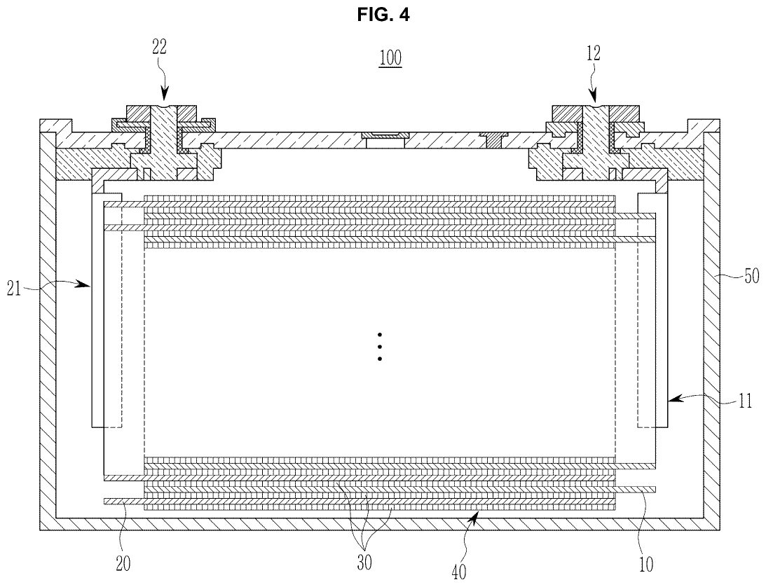

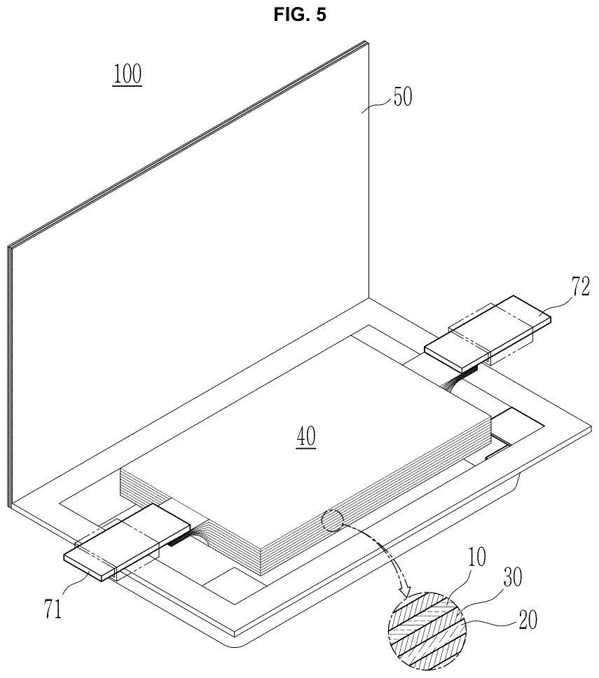

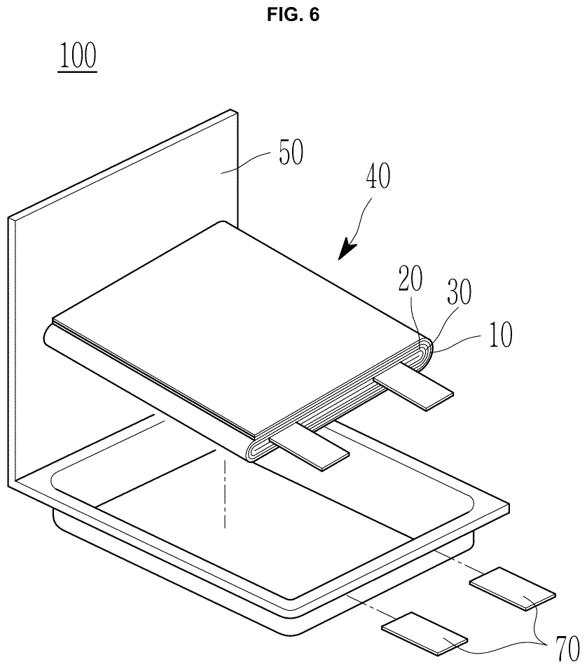

The rechargeable lithium battery may be classified into cylindrical, prismatic, pouch, or coin-type batteries, and/or the like depending on their shape. FIGS. 3 to 6 are schematic views illustrating a rechargeable lithium battery according to an embodiment. FIG. 3 shows a cylindrical battery, FIG. 4 shows a prismatic battery, and FIGS. 5 and 6 show pouch-type batteries. Referring to FIGS. 3 to 6, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. The rechargeable lithium battery 100 may include a sealing member 60 sealing the case 50, as shown in FIG. 3. In FIG. 4, the rechargeable lithium battery 100 may include a positive lead tab 11, a positive terminal 12, a negative lead tab 21, and a negative terminal 22. As shown in FIGS. 5 and 6, the rechargeable lithium battery 100 may include an electrode tab 70, which may be, for example, a positive electrode tab 71 and a negative electrode tab 72 serving as an electrical path for inducing the current formed in the electrode assembly 40 to the outside.

The rechargeable lithium battery according to an embodiment may be applied to automobiles, mobile phones, and/or various types or kinds of electric devices, as non-limiting examples.

Hereinafter, examples and comparative examples of the present disclosure will be described. However, the following examples are merely embodiments of the present disclosure, and the present disclosure is not limited to the following examples.

### Example 1

As a solvent, a mixed solvent containing IPA (isopropyl alcohol) and ETOH (ethanol) in a volume ratio of 3:7 was prepared. 9 parts by weight silicon nanoparticles (D50:100 nm) and 1 part by weight stearic acid were added to 90 parts by weight of the mixed solvent and milled using 5 to 10 mm zirconium balls. Accordingly, a solution in which the silicon nanoparticles were uniformly dispersed in the mixed solvent was obtained.

A slurry for spray drying was obtained by adding iron (III) nitrate to the solution and dispersing the same. A metal (e.g., iron) in the iron (III) nitrate was contained in an amount of 1 part by weight based on 100 parts by weight of silicon nanoparticles in the solution, so the size of a final iron nitrate catalyst became 100 nm. In addition, in the slurry for spray drying (100 wt %), the solid content (i.e., the total amount of the iron (III) nitrate and the silicon nanoparticles) was 10.1 wt %.

Using a spray dryer, the slurry for spray drying was spray-dried under the conditions of 150° C. and at a spray rate of 60 g/min.

60 parts by weight of the product obtained from the spray drying operation was mixed with 40 parts by weight of petroleum-based pitch, a type or kind of amorphous carbon precursor. Then, a negative electrode active material was prepared by raising the temperature from 25° C. to 950° C. at a temperature increase rate of 10° C./min and followed by thermally treating the mixture for 2 hours under an N₂ atmosphere.

### Example 2

As a solvent, a mixed solvent containing IPA and ETOH in a volume ratio of 3:7 was prepared. 9 parts by weight silicon nanoparticles (D50:100 nm) and 1 part by weight stearic acid were added to 90 parts by weight of the mixed solvent and milled using 5 to 10 mm zirconium balls. Accordingly, a solution in which the silicon nanoparticles were uniformly dispersed in the mixed solvent was obtained.

A slurry for spray drying was obtained by adding iron (III) nitrate to the solution and dispersing the same. A metal (e.g., iron) in the iron (III) nitrate was contained in an amount of 1 part by weight based on 100 parts by weight of silicon nanoparticles in the solution, so the size of a final iron nitrate catalyst became 100 nm. In addition, in the slurry for spray drying (100 wt %), the solid content (i.e., the total amount of the iron (III) nitrate and the silicon nanoparticles) was 10.1 wt %.

Using a spray dryer, the slurry for spray drying was spray-dried under the conditions of 150° C. and at a spray rate of 60 g/min.

60 parts by weight of the product obtained from the spray drying operation was mixed with 40 parts by weight of a mixture of petroleum-based pitch, a type or kind of amorphous carbon precursor. Then, a negative electrode active material was prepared by raising the temperature from 25° C. to 950° C. at a temperature increase rate of 2° C./min and followed by thermally treating the mixture for 2 hours under an N₂ atmosphere. The petroleum-based pitch mixture contained 40 wt % petroleum-based pitch with a softening point of 120° C. and 60 wt % petroleum-based pitch with a softening point of 270° C.

### Example 3

As a solvent, a mixed solvent containing IPA and ETOH in a volume ratio of 3:7 was prepared. 9 parts by weight silicon nanoparticles (D50:100 nm), 1 part by weight stearic acid, and 1 part by weight polystyrene were added to 90 parts by weight of the mixed solution and milled using 5 to 10 mm zirconium balls. Therefore, a solution in which the silicon nanoparticles were uniformly dispersed in the mixed solvent was obtained.

A slurry for spray drying was obtained by adding iron (III) nitrate to the solution and dispersing the same. A metal (e.g., iron) in the iron (III) nitrate was contained in an amount of 1 part by weight based on 100 parts by weight of silicon nanoparticles in the solution, so the size of a final iron nitrate catalyst became 100 nm. In addition, in the slurry for spray drying (100 wt %), the solid content (i.e., the total amount of the iron (III) nitrate and the silicon nanoparticles) was 10.1 wt %.

Using a spray dryer, the slurry for spray drying was spray-dried under the conditions of 150° C. and at a spray rate of 60 g/min.

60 parts by weight of the product obtained from the spray drying operation was mixed with 40 parts by weight petroleum-based pitch, a type or kind of amorphous carbon precursor. Then, a negative electrode active material was prepared by raising the temperature from 25° C. to 950° C. at a temperature increase rate of 2° C./min and then thermally treating the mixture for 2 hours under an N₂ atmosphere.

### Comparative Example 1

In Example 1, 60 parts by weight of the product obtained from the spray drying operation was mixed with 40 parts by weight petroleum-based pitch, a type or kind of amorphous carbon precursor. Then, a negative electrode active material was prepared in the same manner as in Example 1, except that the negative electrode active material was prepared by raising the temperature from 25° C. to 950° C. at a temperature increase rate of 2° C./min and followed by thermally treating the mixture for 2 hours under an N₂ atmosphere.

The following physical properties were evaluated using the negative electrode active materials prepared in the Examples and Comparative Examples. A rechargeable lithium battery was manufactured by the method below and then evaluated.

### Manufacture of Rechargeable Lithium Battery

A positive electrode slurry was prepared by mixing 97 wt % LiCoNiAl as a positive electrode active material, 1.5 wt % carbon nanotubes, and 1.5 wt % polyvinyl fluoride as a conductive material and adding water thereto.

A positive electrode was manufactured by applying the prepared positive electrode slurry on an aluminum foil and drying and rolling the same.

A negative electrode active material slurry was prepared by mixing 97.4 wt % of a respective negative electrode active material prepared in the Examples and Comparative Examples, 1.0 wt % carboxymethyl cellulose, 1.5 wt % styrene-butadiene-based rubber, and 0.1 wt % carbon nanotubes as a conductive material. Artificial graphite was used as the second negative electrode active material. A negative electrode was manufactured by applying the prepared negative electrode slurry on aluminum foil and drying and rolling the same.

A battery with a cell capacity of 700 mAh was manufactured by a typical related art method using the negative electrode, the positive electrode, and an electrolyte. As the electrolyte, a mixed solvent of ethylene carbonate, ethyl methyl carbonate, and dimethyl carbonate (a volume ratio of 30:50:20) in which 1.5 M LiPF₆ was dissolved was used.

### (1) Closed Pore Increase Rate (Units: %)

(i) Measurement of closed pore and open pore increase rates:
the closed pore and open pore increase rates (together) were obtained using specific surface area measurements by an SAXS analyzer.

In the Examples and Comparative Examples, the specific surface area of the silicon particle, which is in a state before being mixed with pitch in the preparing of the negative electrode active material, was measured by SAXS analysis.

The specific surface areas of the finally prepared negative electrode active materials in the Examples and Comparative Examples were measured by SAXS analysis.

(ii) Measurement of open pore increase rate:
the open pore increase rate was obtained using specific surface area measurements by a BET analyzer (BELSORP-mini II, BEL Japan). Specifically, the specific surface area was calculated from the amount of adsorbed nitrogen gas at a liquid nitrogen temperature (77 K).

In the Examples and Comparative Examples, the specific surface area of the silicon particle, which is in a state before being mixed with pitch in the preparing of the negative electrode active material, was measured by BET analysis.

The specific surface areas of the finally prepared negative electrode active materials in the Examples and Comparative Examples were measured by BET analysis.

The closed pore increase rate was obtained by Equation 1 using the increase rates measured from (i) and (ii).

### (2) Expansion Rate of Battery (Units: %)

The charging and discharging of the manufactured rechargeable lithium battery (full-cell) at 25° C. (room temperature) under the following conditions were set as one cycle, and a total of 25 cycles were performed with a 3-minute rest period between the cycles.

Charging conditions: constant current (CC)/constant voltage (CV) (4.25 V, 0.005 C current cut-off)

Discharging conditions: constant current (CC) condition (3 V)

A battery expansion rate is defined as a percentage ratio of a battery thickness Tx to an initial battery thickness T1 after charging and discharging 25 times, that is, a value of [{(Tx−T1)/T1}×100%].

### (3) Initial Efficiency (Units: %) and Capacity Maintenance Rate (Units: %)

The charging and discharging of the rechargeable lithium battery (full-cell) at 25° C. (room temperature) under the following conditions were set as one cycle, and a total of 50 cycles were performed with a 3-minute rest period between the cycles.

Charging conditions: constant current (CC)/constant voltage (CV) (4.25 V, 0.005 C current cut-off)

Discharging conditions: constant current (CC) condition (3 V)

Battery initial efficiency (coulombic efficiency) [%] was set to 100%×[(initial charging capacity)/(capacity after initial discharging)], and
the capacity maintenance rate [%] was set to 100%×[(discharging capacity after 50 cycles)/(capacity after initial discharging)].

TABLE 1

| | | | | Capacity |
|---|---|---|---|---|
| | Closed pore | Battery | Initial | maintenance |
| | increase rate | expansion rate | efficiency | rate |
| Example 1 | ◯ | ◯ | ◯ | Δ |
| Example 2 | ◯ | Δ | ◯ | ◯ |
| Example 3 | ◯ | ◯ | Δ | ◯ |
| Comparative | Δ | X | ◯ | ◯ |
| Example 1 | | | | |

Because the four parameters, that is, closed pore increase rate, battery expansion rate, initial efficiency, and capacity maintenance rate are all ratios of changed values compared to the initial value, the symbol O, Δ, and X are marked according to a difference in a change rate compared to the value of the Comparative Example due to the processes of the Examples rather than absolute values that may vary depending on the measurement conditions.

### Closed Pore Increase Rate:

20% or more and 100% or less: O
10% or more and less than 20%, more than 100% and 110% or less: Δ
Less than 10% and more than 110%: X

### Battery Expansion Rate:

10% or less: O
More than 10% and less than 20%: Δ
20% or more: X

### Initial Efficiency:

85% or more: O
80% or more and less than 85%: Δ
Less than 80%: X

### Capacity Maintenance Rate:

85% or more: O
More than 80% and less than 85%: Δ
80% or less: X

As shown in Table 1, the silicon-based negative electrode active materials prepared in the Examples each had a better battery expansion rate, better initial efficiency, and a better capacity maintenance rate than the Comparative Example.

According to one or more embodiments, a negative electrode active material for a rechargeable lithium battery has a closed pore increase rate in a range of 20% to 100% calculated according to Equation 1. The closed pore increase rate is calculated by subtracting the increase rate of only the open pores from the sum of the increase rate of closed pores and the increase rate of open pores. Each component of Equation 1, i.e., A and B, is obtained based on the specific surface area of the negative electrode active material measured during the manufacturing process of the negative active material, e.g., before any open pores and closed pores are formed, and that measured after the negative electrode active material is finally formed at the completion of the manufacturing process. The specific surface area accounting for both open pores and closed pores is measured according to a first measurement method that is capable of measuring the specific surface area of both open pores and closed pores, and the specific surface area of only the open pores is measured according to a second measurement method (e.g., that does not account for the specific surface area of the closed pores).

A negative electrode active material for a rechargeable lithium battery according to one or more embodiments can exhibit significantly lower volume expansion upon intercalation and deintercalation of lithium and provide a longer lifetime and improved rate characteristics.

The negative electrode active material for a rechargeable lithium battery according to one or more embodiments can provide a longer lifetime and improved rate characteristics by resolving the depletion of an electrolyte caused by an increase in (e.g., growth of) an oxide film due to volume expansion and contraction and an increase in resistance due to low conductivity if silicon is used as a negative electrode active material.

It will be understood that the terms “includes,” “including,” “comprises,” and/or “comprising,” when used in this specification, specify the presence of stated features, steps, operations, elements, and/or components, but do not preclude the presence or addition of one or more other features, steps, operations, elements, components, and/or groups thereof. As used herein, the term “combination thereof” refers to a mixture, a laminate, a composite, a copolymer, an alloy, a blend, a reaction product, and/or the like of the constituents.

As used herein, the terms “use,” “using,” and “used” may be considered synonymous with the terms “utilize,” “utilizing,” and “utilized,” respectively. As used herein, expressions such as “at least one of”, “one of”, and “selected from”, when preceding a list of elements, modify the entire list of elements and do not modify the individual elements of the list. For example, “at least one selected from among a, b and c”, “at least one of a, b or c”, and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

The use of “may” when describing embodiments of the inventive concept refers to “one or more embodiments of the inventive concept.”

As used herein, the term “about,” and similar terms are used as terms of approximation and not as terms of degree, and are intended to account for the inherent deviations in measured or calculated values that would be recognized by those of ordinary skill in the art. “About” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

Although example embodiments of the present disclosure have been described above, the present disclosure is not limited thereto and may be modified in any form within the scope of the claims, and equivalents thereof, the detailed description of the present disclosure, and the accompanying drawings, and it goes without saying that the modifications also fall within the scope of the present disclosure.

What is claimed is:

1. A negative electrode active material for a rechargeable lithium battery, comprising a composite of silicon and amorphous carbon,
wherein the negative electrode active material has a closed pore increase rate in a range of 20% to 100% according to Equation 1:
$$Closed pore increase rate = ( A - B ) \times 100 \qquad Equation 1$$
in Equation 1, A denotes a sum of an increase rate of closed pores and an increase rate of open pores of the negative electrode active material according to a first measurement method, and B denotes an increase rate of open pores of the negative electrode active material according to a second measurement method.

2. The negative electrode active material as claimed in claim 1, wherein the negative electrode active material comprises a silicon particle and amorphous carbon with which a surface of the silicon particle is coated.

3. The negative electrode active material as claimed in claim 1, wherein the negative electrode active material comprises a secondary particle in which silicon primary particles are agglomerated and an amorphous carbon coating layer on a surface of the secondary particle.

4. The negative electrode active material as claimed in claim 1, wherein the amorphous carbon is soft carbon, hard carbon, pitch, pitch carbide, calcined coke, or a combination thereof.

5. The negative electrode active material as claimed in claim 1, wherein the amorphous carbon comprises a mixture of a first amorphous carbon having a first softening point and a second amorphous carbon having a second softening point different from the first softening point, and/or a carbide of the mixture.

6. The negative electrode active material as claimed in claim 5, wherein the first softening point is 100° C. or higher and 250° C. or lower, and the second softening point is higher than 250° C. and 500° C. or lower.

7. The negative electrode active material as claimed in claim 2, wherein the silicon particle includes a closed pore and an open pore.

8. The negative electrode active material as claimed in claim 1, wherein the first measurement method comprises small-angle X-ray scattering (SAXS), and the second measurement method comprises a Brunauer-Emmett-Teller (BET) analysis method.

9. The negative electrode active material as claimed in claim 1, wherein A in Equation 1 is calculated by Equation 2, and B in Equation 1 is calculated by Equation 3:
$$A = ( EA - PA ) / PA \qquad Equation 2$$
in Equation 2, PA denotes a specific surface area according to the first measurement method before the open pores and the closed pores of the negative electrode active material are formed, and EA denotes a specific surface area according to the first measurement method after the open pores and the closed pores of the negative electrode active material are formed, and
$$B = ( EB - PB ) / PB \qquad Equation 3$$
in Equation 3, PB denotes a specific surface area according to the second measurement method before the open pores and the closed pores of the negative electrode active material are formed, and EB denotes a specific surface area according to the second measurement method after the open pores and the closed pores of the negative electrode active material are formed.

10. The negative electrode active material as claimed in claim 9, wherein the negative electrode active material is prepared by a preparation method comprising:
providing a silicon particle in a first operation; and
preparing a silicon-based negative electrode active material by forming an amorphous carbon coating layer on a surface of the silicon particle in a second operation, and
the PA and the PB are measured after the first operation and before the second operation.

11. A method of preparing a negative electrode active material for a rechargeable lithium battery, the method comprising:
providing a silicon particle in a first operation, and
preparing a silicon-based negative electrode active material by forming an amorphous carbon coating layer on a surface of the silicon particle in a second operation,
wherein, in one or both of the first operation and the second operation, a closed pore increase rate of the negative electrode active material according to Equation 1 is adjusted to 20% to 100%:
$$Closed pore increase rate = ( A - B ) \times 100 \qquad Equation 1$$
in Equation 1, A denotes a sum of an increase rate of closed pores and an increase rate of open pores of the negative electrode active material according to a first measurement method, and B denotes the increase rate of open pores of the negative electrode active material according to a second measurement method.

12. The method as claimed in claim 11, wherein the silicon particle comprises a secondary particle in which silicon primary particles are agglomerated.

13. The method as claimed in claim 11, wherein the silicon particle comprises a thermally decomposable material, and at least 50 wt % or more of the thermally decomposable material is thermally decomposed in the second operation.

14. The method as claimed in claim 13, wherein the thermally decomposable material comprises a polystyrene-based resin and/or a polymethyl methacrylate-based resin.

15. The method as claimed in claim 13, wherein the thermally decomposable material is 0.1 to 3 wt % in amount based on 100 wt % of the silicon particle.

16. The method as claimed in claim 11, wherein the second operation comprises a heat treatment, and
the heat treatment is performed at a temperature in a range of 700° C. to 1000° C. after raising at a temperature increase rate in a range of 5° C./min to 20° C./min.

17. The method as claimed in claim 11, wherein the second operation comprises subjecting a mixture of amorphous carbons with different softening points to a heat treatment, and
the mixture comprises a first amorphous carbon having a softening point of 100° C. or higher and 250° C. or lower, and a second amorphous carbon having a softening point of higher than 250° C. and 500° C. or lower.

18. A rechargeable lithium battery comprising:
a negative electrode comprising the negative electrode active material as claimed in claim 1;
a positive electrode; and
an electrolyte.

19. A rechargeable lithium battery comprising:
a negative electrode comprising the negative electrode active material prepared by the method as claimed in claim 11;
a positive electrode; and
an electrolyte.
